(19) United States
(12) Patent Application Publication
(10) Pub. No.: US 2007/0083462 A1
(43) Pub. Date: Apr. 12, 2007

(54) Method for coordinating investor--guaranteed loans over the internet

(76) Inventors: Echeyde Cubillo, San Ramon, CA (US); Leonard Speiser, Redwood City, CA (US); Michael Lawrence Serpa, Oakland, CA (US)

Correspondence Address: ECHEYDE CUBILLO, 5012 Lakeview Drive, #101, San Ramon, CA, 94582, US

(21) Appl. No.: 11/248,840

(22) Filed: Oct. 12, 2005

(51) Int. Cl. G06Q 40/00

(52) U.S. Cl. 705/38

(57) ABSTRACT

A method for coordinating investor-guaranteed loans over the internet whereby borrowers submit loan requests to a database and investors search the database and select borrowers. The investors then consent to act as guarantors on loans made to the selected borrowers and, in addition, make an investment by contributing funds to an intermediary. The intermediary lends money to the selected borrowers. The resulting investor-guaranteed loans are serviced by the intermediary. To enhance user benefits, the method further enables both borrowers and investors to form personal and/or community relationships or associations which can accompany or transcend the borrower/guarantor relationship.

### FIELD OF THE INVENTION

This invention relates to methods established to assist borrowers seeking credit. In particular, it relates to the coordination of loans, and loan guarantees from investors, via the internet.

### BACKGROUND OF THE INVENTION

A variety of both personal and commercial entities have recognized the internet as an important new medium for communication. Because it facilitates a speedy and inexpensive exchange of information, there are countless opportunities to exploit this unique technology. As a result, the internet has now become a preferred method for transacting business and is also widely used to start and strengthen personal relationships.

Among the commercial entities exploiting the internet's possibilities are many engaged in the practice of arranging or making loans. Numerous websites and/or online auction systems enabling lenders and borrowers to locate one another have been created, and additional related efforts will almost certainly follow.

Though various methods are known for accomplishing loan transactions using the internet, much of the prior art is generally focused on transferring traditional loan processing techniques to the online environment. That is, the internet is merely used to provide an alternative connection between existing lenders and borrowers seeking credit. The vast resources and economies of scale offered by the internet do allow for comparison/shopping opportunities that were less manageable before (such as permitting a borrower to apply for credit from a multitude of lending institutions without having to physically go to or call each lender and fill out an application), but the end results of these transactions resemble traditional practices for the most part.

More innovative ventures in this arena offer loan participation networks and peer-to-peer lending models. Some of these arrangements hold particular appeal to certain user groups less inclined towards traditional credit practices.

Although the above methods have value, yet they might not be suitable for all users. For example, some individuals may prefer to provide a source of funding for loans in exchange for a potential return on their investment. These users are not served by prior art models that fund loans from institutional sources. Furthermore, these investors seeking interest income might want to avoid the responsibility for initiating/undertaking collection efforts upon borrower default and could therefore be disinclined to contract directly as a lender with borrowers. Existing online lending models do not present acceptable alternatives.

On the other side are users who need credit and desire to obtain loans. Yet some potential borrowers might not qualify for loans under existing peer-to-peer lending arrangements or online models governed by conventional underwriting constraints. Improvements to the borrower's perspective would open new possibilities as well.

Therefore, an online lending format which overcomes these and other limitations—resulting in an entirely novel approach to coordinating loans—would be useful. The method of the present invention provides such a format. It employs the vast resources of the internet to bring disparate users together in mutually beneficial borrower-guarantor relationships managed by one or more intermediaries. Furthermore, the method of the present invention provides a structure that can foster positive social interactions which transcend the extension of credit.

### SUMMARY OF THE INVENTION

It is therefore an object of the present invention to provide a convenient online process by which borrowers can obtain loans and investors can earn a return on an investment.

It is a further object of the present invention to provide a distinctive avenue for the formation and maintenance of personal relationships and/or user communities over the internet.

To achieve these and other objects of the invention, there is provided a method for coordinating borrower/guarantor relationships between or among internet users. Investors contribute funding to an intermediary and agree to serve as third-party loan guarantors for specific investor-selected borrowers. The intermediary invests the contributions in loans made to the selected borrowers. In exchange for their guarantees, the investors receive a return on their investment as the loans are repaid. The intermediary acts as lender to the borrowers and transmits investment returns to investor accounts. Investors select borrowers based on borrower credit scoring data as well as other information provided to the intermediary, by borrowers, for display to investors. This other information allows for a social networking that can both: (i) help borrowers attract potential guarantors (whereby credit can be extended); and (ii) enable investors to make their guarantor decisions based on specific borrower attributes in addition to borrower credit scoring data.

As an alternative, multiple intermediaries could manage the process. For example, one intermediary could receive the investor's contribution and a second intermediary could complete the task of funding the borrower's loan.

Investment returns earned by the investors on their contributions can consist of one or more of the following: interest income, a share of late payment penalty fees, and a share of proceeds from the sale of any uncollectible debt.

Responsibility for processing loan payments as well as responsibility for taking enforcement action upon borrower default rests with the intermediary. But because the investors serve as guarantors for the borrower loans, investors bear the risk of borrower default. The return on investment earned by investors is dependent upon borrowers' timely/eventual repayment of loan principal amounts plus required interest and any late fees.

In a preferred embodiment of the method of the present invention, investor contributions would be spread among a plurality of borrowers, and investors will serve as guarantor only to the extent of their participation percentage in a specific loan (meaning that each borrower loan will be guaranteed by a plurality of investors). Thus, the risk of a specific borrower's default will be spread among multiple investors. This would serve to help maintain investor confidence in the system as well as maximize positive investor return-on-investment through diversification.

Ideally the method of the present invention employs a computerized system comprised of an Internet-accessible database storing credit and other data from users seeking loans. The system further comprises a database management program for searching the database. Investors search the database to identify select borrowers based on information in the system. Once identified, an investor transmits to the system their consent to act as a guarantor for the selected borrowers. The investor also authorizes a transfer of funds an intermediary. The intermediary (or a second intermediary) lends funds to the investor-selected borrowers and processes loan payments as they are made, forwarding to the investor's account their share of the loan payments as investment returns. The system preferably also includes a status posting by which borrowers can check on their loan status and investors can check on the status of those loans which they have guaranteed.

Borrower searches can be permitted in addition to investor searches. For example, as will be described below, borrowers can solicit investor attention by searching for specific user groups.

In a preferred embodiment, the system includes a website which makes clear to users the method of the present invention and which takes borrowers/investors step-by-step through the lending/investing process.

### BRIEF DESCRIPTION OF THE DRAWINGS

FIG. 1 is a flow chart showing the method of an illustrative embodiment.

FIG. 2 is a sample screen image of a homepage for a website implementing an embodiment of the invention.

FIG. 3 is a sample screen image of a prospective investor's search results.

FIG. 4 is a sample screen image providing non-credit scoring data information of a prospective borrower.

### DETAILED DESCRIPTION AND OPERATION

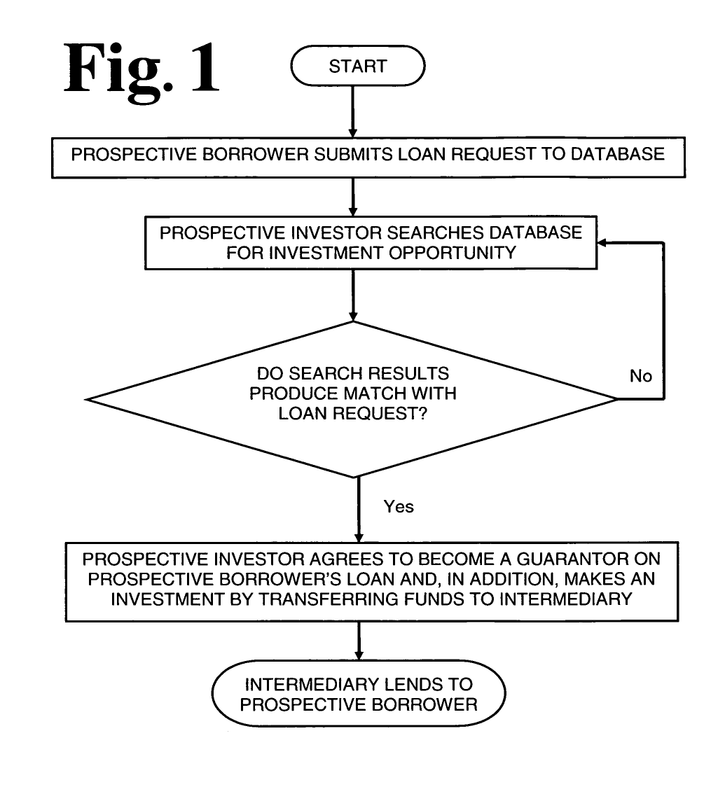

Referring to FIG. 1, there is shown a flow chart of an illustrative embodiment. A prospective borrower, seeking a loan, submits via the internet a loan request to a database operated by an intermediary. Preferably the loan request includes a requested loan principal and might also, as discussed below, include personal information about the prospective borrower as well as the purpose of the loan request.

In submitting the loan request, the prospective borrower might authorize the intermediary to access and use personal credit data of the prospective borrower as maintained by a credit reporting bureau. The loan request is stored in the database. If used, the personal credit data is also stored in the database—or stored in a separate database—in accordance with proper security practices. In one embodiment of the invention, the intermediary provides a viewable rating for the prospective borrower derived from the prospective borrower's personal credit data.

On the other side of the transaction, a prospective investor searches the database via the internet for an investment opportunity. The investment opportunity takes the form of a loan request that appeals to the investor. If, as discussed above, the intermediary has given a prospective borrower a viewable rating derived from that borrower's personal credit data, the viewable rating might be displayed in the prospective investor's search results to assist the prospective investor in making the investment decision.

An interest rate for the loan sought by the prospective borrower can be set in a number of ways. For example, the interest rate can be specified by the prospective borrower in the loan request, or it can be set by the intermediary using the personal credit data. As another other option, a rate can be specified by the prospective investor. As a still further possibility, a biding system could be implemented whereby separate prospective investors offer—or choose from—multiple interest rates depending upon specific attributes of the prospective borrower. Many possibilities exist here, and specific choices will depend on circumstances.

If the prospective investor decides that the prospective borrower's loan request is an acceptable investment opportunity, the prospective investor can make an investment in a loan to the prospective borrower. The prospective investor authorizes a transfer of funds to the intermediary for the amount of the investment and also agrees to act as guarantor for the loan to the prospective borrower to the extent of the investment—thereby becoming an investor/guarantor. (As an example, if a borrower obtains a $1,000 loan from ten separate investor/guarantors who each invested $100 in the loan, individual investor/guarantors would only serve as guarantor for their respective $100 shares of the loan. Each investor/guarantor's potential loss on the loan would be limited to $100.)

To complete the transaction, the intermediary then transfers to an account used by the prospective borrower an amount equal to the requested loan principal. At this point, the transaction becomes a loan, the requested loan principal becomes the principal balance, and the prospective borrower then becomes a loan recipient.

The loan is serviced by the intermediary. When the loan recipient makes a payment on the loan, the intermediary remits to an account used by the investor/guarantor an amount equal to the investor/guarantor's share of these proceeds (e.g. principal repayment, interest, and a share of any late payment fees).

As stated above, a particular loan can be funded by pooled contributions from a plurality of investor/guarantors, thus spreading the risk of loan recipient default.

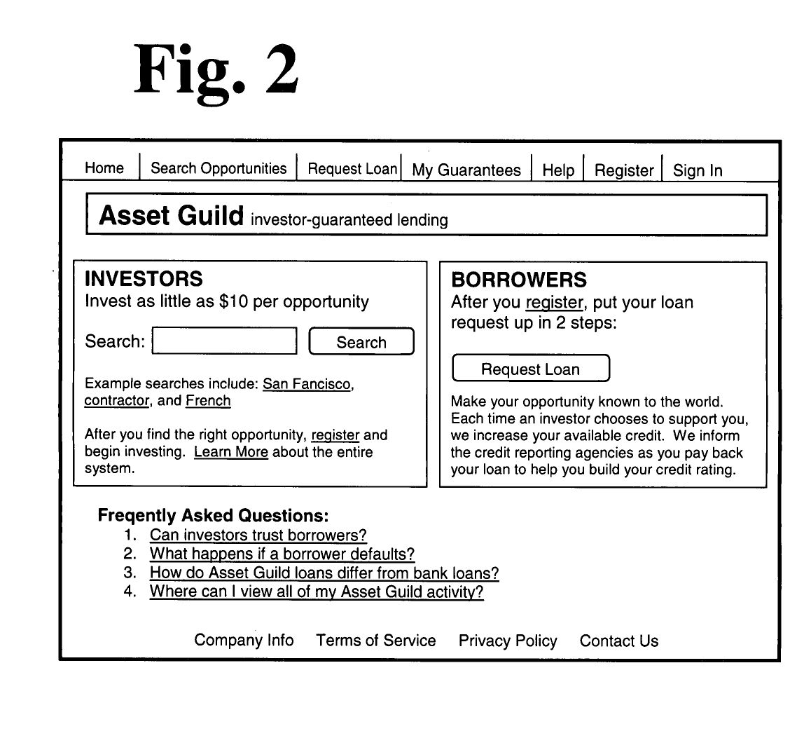

In FIG. 2 is shown a sample homepage for a website implementing the present invention. Prospective investors complete a search field with preferred investment parameters to find one or more acceptable prospective borrowers, and proceed via the homepage to a loan application page (not shown). Ideally the invention would be implemented by an easily navigable website which explains the process in a user-friendly manner. The website can include pages translated into different languages to accommodate a wider range of users.

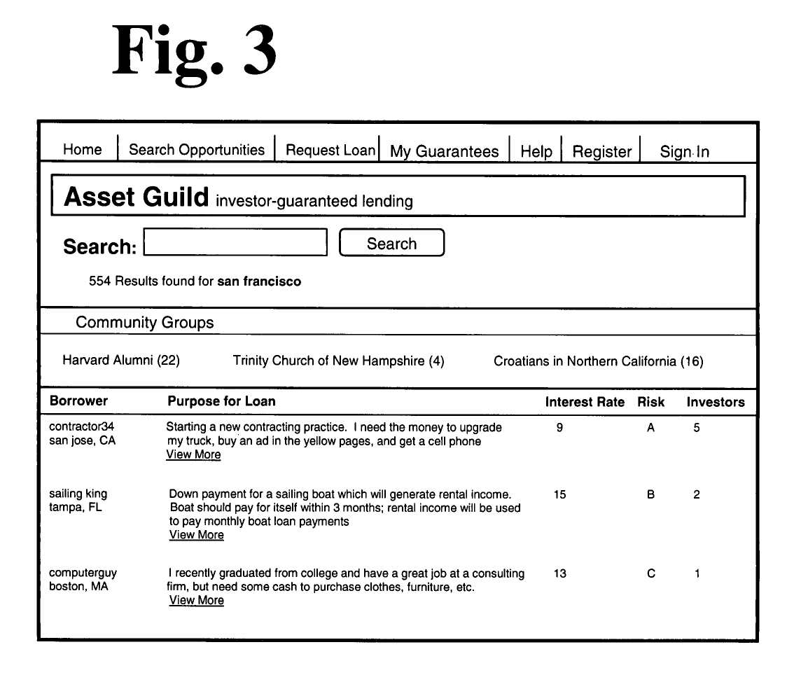

After a prospective investor completes their search parameters in an effort to locate prospective borrowers, the database will produce search results that can be displayed for viewing. A sample screen image of such search results is shown in FIG. 3. Information provided to the database by prospective borrowers gives the reason for each loan request, and prospective investors can see the number of prospective investors committed to guarantee loans made in response to loan requests that have been submitted. In the sample screen image of FIG. 3, the intermediary has included a viewable rating for each prospective borrower derived from personal credit data on the prospective borrowers.

A particular advantage offered by the present invention permits prospective borrowers (and loan recipients) to form personal and/or community relationships or associations with prospective investors (and investor/guarantors) around unique attributes and/or factors which do not normally weigh on credit decisions. These personal and community relationships can precede, accompany, or follow an extension of credit under the present invention.

For example, a particular user or user group might desire to associate with others sharing a common bond. Thus, a user group comprised of “Artists from Northern California” would serve to provide investor/guarantors and loan recipients who desire to assist—and receive funding assistance from—members of this group. Other users might desire to associate with individuals from a particular ethnic group, those having a particular religious affiliation, or people who participate in a certain leisure activity or hobby. Both prospective investors and prospective borrowers can search the database to locate other users with desired qualities.

Additional affiliations could be based around the city or town where users live, permitting investor/guarantors to engage in transactions they know will help their own communities (and allowing loan recipients to benefit from local support).

Particular reasons for these user associations need not be purely altruistic; they can relate directly to determinations necessary for using the present invention. For instance, an alumnus of a particular university or college might decide that their fellow alumni would be better credit risks than members of other populations and could therefore search for prospective borrowers having this attribute. Similar results could flow from user communities based on certain occupations, age groups, birth dates, etc.

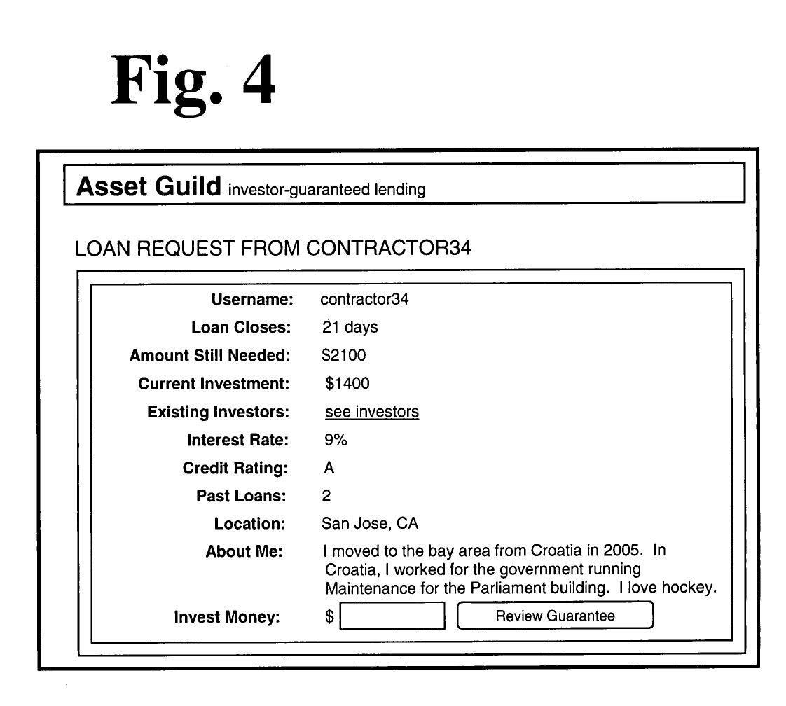

If a prospective borrower desires to convey personal details and/or other information (such as extensive information covering the purpose of the loan request) to prospective investors to foster a user alliance, they can include such information when completing their loan request. An example of this is shown in the sample screen image of FIG. 4. The prospective borrower who had made this loan request chose to include personal information unrelated to the need for credit. A prospective investor with similar interests/attributes might therefore be more inclined to transact with this prospective borrower as opposed to others.

Photos can also be part of the personal details and/or other information.

Another embodiment of the present invention could include “social networking features” to enable users to continue these personal/community relationships outside the boundaries of the loan/investment context. The website implementing the invention could have various other features such as bulletin boards, chat rooms, information exchanges, and the like, to accomplish this. User might also be encouraged to take advantage of the social networking features even if they lack a present interest in the credit/investment aspect of the present invention. Personal relationships and/or community associations can form before individual users begin seeking loans or investment opportunities. Thus, prospective investors (as well as investor/guarantors) may desire to include in the database information about themselves which might foster personal and/or community relationships.

As a still further embodiment of the present invention, multiple databases can be employed in place of a single database, if preferred.

Again, as stated above, database searches can be initiated by any user of the present invention. Prospective borrowers, prospective investors, loan recipients,

Again, as stated above, database searches can be initiated by any user of the present invention. Prospective borrowers, prospective investors, loan recipients, and investor/guarantors might, for various reasons, choose to perform a search.

Although the description above contains several specificities, these should not be construed as limiting the scope of the present invention, but as merely providing illustrations of some of the presently preferred embodiments. It is to be therefore understood that many changes and modifications by one of ordinary skill in the art are considered to be within the scope of the invention. Thus the scope of the invention should be determined by the appended claims and their legal equivalents, rather than by examples given.

We claim:

1. A method for coordinating investor-guaranteed loans over the internet, comprising the steps of:
receiving a loan request from a prospective borrower;
storing the loan request in a database;
a prospective investor searching the database;
the prospective investor selecting the prospective borrower;
the prospective investor agreeing to act as a guarantor on a loan to the prospective borrower;
the investor making an investment by contributing funds to an intermediary;
the intermediary making a loan to the prospective borrower, the prospective borrower becoming a loan recipient.
the loan being guaranteed by the prospective investor, the prospective investor becoming an investor/guarantor.

2. The method of claim 1, wherein the loan is guaranteed by more than one investor/guarantor.

3. The method of claim 1, including more than one intermediary.

4. The method of claim 1, including more than one database.

5. The method of claim 1, further comprising the step of the prospective borrower searching the database.

6. The method of claim 1, including more than one loan recipient and/or more than one investor/guarantor.

7. A method for coordinating investor-guaranteed loans over internet, wherein a prospective borrower submits via the internet a loan request to a database;
the loan request being stored in the database;
a prospective investor searches the database via the internet and the search produces a search results;
the search results being the prospective borrower's loan request;
the prospective investor then agreeing to guarantee all or a portion of a loan to the prospective borrower made by an intermediary;
the prospective investor making an investment by contributing funds to the intermediary;
the intermediary lends money to the prospective borrower.

8. The method of claim 7, wherein the search results include a viewable rating for the prospective borrower.

9. The method of claim 7, wherein the search results include personal details and/or other information about the prospective borrower enabling the formation of a personal and/or community relationship or association with the prospective investor.

10. The method of claim 7, wherein the loan to the prospective borrower is guaranteed by more than one prospective investor.

11. The method of claim 7, further including social networking features.

12. The method of claim 7, including more than one intermediary.

13. A method for coordinating investor-guaranteed loans over the internet whereby:
prospective borrowers submit loan requests to a database, and the loan requests present investment opportunities for prospective investors;
the prospective investors search the database for investment opportunities;
the prospective investors select investment opportunities and agree to serve as guarantors on loans made by an intermediary to the prospective borrowers whose loan requests created the selected investment opportunities;
the prospective investors make investments by transferring funds to the intermediary, and the prospective investors become investor/guarantors.
the intermediary lends money to the prospective borrowers, and the prospective borrowers become loan recipients.

14. The method of claim 13, wherein the loan requests include personal details and/or other information about prospective borrowers.

15. The method of claim 13, wherein the database includes social networking features.

16. The method of claim 13, wherein more than one database is employed.

17. The method of claim 13, including more than one intermediary.

18. The method of claim 13, wherein the prospective borrowers have the option of including a viewable rating in their loan requests.
